(19) United States
(12) Patent Application Publication
(10) Pub. No.: US 2019/0393671 A1
(43) Pub. Date: Dec. 26, 2019

(54) TUNABLE NONLINEAR SOLID STATE RAMAN LASER SOURCE

(71) Applicant: IPG PHOTONICS CORPORATION, OXFORD, MA (US)

(72) Inventors: Igor MOCHALOV, Oxford, MA (US); Andrey KOSTERIN, Oxford, MA (US); Alexander SANDULENKO, Oxford, MA (US)

(21) Appl. No.: 16/481,722

(22) PCT Filed: Jan. 30, 2018
(86) PCT No.: PCT/US18/15906

§ 371 Date: Jul. 29, 2019

Related U.S. Application Data
(60) Provisional application No. 62/452,082, filed on Jan. 30, 2017.

(51) Int. Cl. H01S 3/30; H01S 3/08; H01S 3/06; H01S 3/094

(52) U.S. Cl. CPC H01S 3/30; H01S 3/08095; H01S 3/094076; H01S 3/094042; H01S 3/0621

(57) ABSTRACT

A crystalline Raman laser source is configured with a crystal Raman medium zigzagged by a pump light at a fundamental frequency of between input and output of the Raman medium such that the pump light sequentially converts to Stokes wave frequencies υ₁-υn, the Raman medium having spaced opposite sides bridging the input and output. The Raman medium is provided with a wavelength discriminator coupled to the opposite sides of the Raman medium and configured to guide a desired Stokes frequency to the exit of the Raman medium while being transparent to Stokes wave frequency which is lower than the desired frequency.

### BACKGROUND OF THE DISCLOSURE

### 1. Field of the Disclosure

The disclosure relates generally to frequency conversion of laser beams, and in particular to a solid state Raman-active medium for generating laser beams at the desired frequencies. In particular, the present disclosure relates to a selectable multi-wavelength solid state Raman laser system, a method for selectively providing an output laser beam from the laser system at different wavelengths and applications based on the disclosed system and method.

### 2. Background of the Related Art

The lasers available today, especially tunable devices, span a considerable range of wavelengths. Still, modern lasers are not capable of generating beams of sufficient quality at all desirable wavelengths. For this reason, frequency shifting or converting systems are used to derive the required frequencies. It is important that such systems produce high quality beams, i.e., beams of high intensity, and exhibit wavelength diversity and agility. In this case, wavelength diversity refers to the ability of producing laser beams at many different wavelengths, while wavelength agility is a measure of the maximum spread of wavelengths.

Techniques for shifting the wavelength of a laser beam are well known to one of ordinary skill in the laser arts. There are a number of elements which are capable of receiving a beam at a particular frequency and shifting it to a different frequency. These elements include Raman media. Stimulated Raman scattering (SRS), i.e., laser-stimulation of scattering in a Raman-active medium, is based on the Raman phenomenon briefly explained immediately below.

An intense laser beam incident on a molecular medium with internal degrees of freedom may be scattered by that medium in a variety of processes. In one of these, Raman scattering, following an inelastic collision a molecule is left in an excited state, and the scattered photon produced by interaction with that molecule will experience a wavelength shift in accordance with the principle of energy conservation. In the case where the molecule makes a transition to a higher energy level, the photon is scattered with a lower energy than it had when it arrived and thus has a longer wavelength than the incident light. This type of wavelength shift is called a Stokes shift. In the event where the molecular transition is to a lower energy level, the scattered photon carries away the excess energy, and thus has higher energy and longer wavelength than the incident light. The shifting to a longer wavelength is called an anti-Stokes shift.

Solid-state Raman lasers are a practical and efficient approach to optical frequency conversion, offering high (up to 70 to 80%) conversion efficiencies with respect to the pump power, excellent beam quality and ease of alignment. The use of crystals for SRS has been gaining interest because, in comparison, for example, with fiber Raman converters, crystalline Raman lasers offer greater gain increments, better thermal and mechanical properties, and significantly greater values of Raman shift. The greater gain coefficient leads to significant decrease of Raman conversion thresholds. The thermal and mechanical stability allow higher peak and average pulse pump powers and high pulse repetition frequency. The greater values of Raman shifts facilitate the concentration of energy at the desired Stokes and allow suppressing the parametric processes.

The Raman laser systems including solid-state Raman converters use many technological advances in the areas of light sources, fiber optic guides, spectrometers, medicine, red, green and blue (RGB) luminaire systems for digital cinema and etc, making Raman scattering a valuable tool in a variety of industrial, research and other applications. Many of these fields require the availability of different wavelengths.

In this regard, U.S. Pat. No. 4,165,469 teaches a solid-state laser capable of providing different frequencies of laser output light. Yet, the laser as taught, is limited to the use of lithium iodate crystal, which performs the functions of both Raman-shifter and frequency doubler to generate a plurality of possible output frequencies based on the frequency-doubled first, and then second or higher order Stokes stimulated Raman scattering. This limitation may be disadvantageous, as the disclosed converter is limited to the output frequencies obtainable using lithium iodate, since it is rare to find crystals capable of performing both of these functions together. Another disadvantage is that, since the lithium iodate crystal serves two discrete functions, it may not be possible to optimize the position of that crystal independently for two functions. Yet a further disadvantage is that lithium iodate has limited utility in high power applications, since it has a relatively low damage threshold.

Therefore a need exists for a tunable Raman laser system.

There is a further need for a tunable Raman laser system having a simple structure that can be deployed in the field without undue difficulty.

### SUMMARY OF THE INVENTION

These needs are met by the disclosed structure and method teaching the arrangement of optical components that cumulatively allow increasing the length of optical path propagated by a desired Stokes wave frequency υd and a Stokes wave frequency υd−1 through a solid state Raman medium. The Stokes wave frequency acts as pump light for the desired wave frequency υd. For example, if the desired frequency is a first Stokes frequency υ1, then it is light from an external light source at a fundamental frequency υf that functions as pump light for the first Stokes in the Raman medium. The efficiency of Raman wavelength conversion depends on how long the waves at desired and pump frequencies are overlapped while propagating through the Raman medium. The efficiency increases with a longer overlap.

As light propagates through the Raman medium, the first Stokes that becomes pump light for a second Stokes wave frequency, which, in turn, becomes pump light for a third Stokes, etc. This process can continue over a wide range of Stokes frequencies. With the energy transfer between previous and subsequent Stokes, obviously the energy of the previous Stokes is depleted. Accordingly, while it is highly desired to create conditions for long interaction between the pump and desired pump frequencies, it is essential that a frequency higher than the desirable one be removed from the Raman medium as soon as possible. Thus on one hand, the optical interaction length through the Raman medium for fundamental and first Stokes wave frequencies is critical. On the other hand with a relatively great length, the firsts Stokes in the above-described example may generate a subsequent, second Stokes and thus loose its energy. Accordingly, the second Stokes should be filtered out from the Raman medium without undue delay.

In accordance with one aspect of the disclosure, a solid state Raman medium is configured with a crystal zigzagged by pump light between input and output of the crystal such that the pump light sequentially converts to Stokes wave frequencies υ₁-υn. The Raman medium further is configured with spaced opposite sides bridging the input and output and a wavelength discriminator which is configured to guide the desired Stokes frequency to the exit of the Raman medium while being transparent to a Stokes wave frequency which is lower (i.e., longer wavelength) than the desired frequency. For example, if the first Stokes wave frequency υ₁ is desired, then the second Stokes wave is filtered out along the light path through the Raman medium.

In accordance with another aspect of the disclosure, a Raman laser source includes an external laser pump operative to emit pump light at a fundamental frequency of along a path through the solid state Raman medium of the above aspect.

A further aspect of the disclosure that may be incorporated in the structure of any of the above aspects relates to the output of the Raman medium. It is configured to be transparent to the desired Stokes wave frequency, but reflects the remaining unconverted part of the pump light at the fundamental frequency back into the Raman medium towards the input. Returning to the example above, if the first Stokes is desired, then the pump light at fundamental frequency of is reflected back into the medium while the second Stokes is being filtered out. If the second Stokes is the desired frequency, the fundamental and first Stokes wave frequencies are reflected back into the Raman medium, while the third Stokes is being removed from the Raman medium upstream from the the exit.

In accordance with a further aspect, the wavelength discriminator of any of the above aspects is configured with a plurality of discreet reflectors. The reflectors include an inner layer facing the side of the Raman medium and one or more outer layers. The layers, from the inner one out, reflect respective fundamental frequency, Raman wave frequencies higher than the desired Raman wave frequency and desired Raman wave frequency back into the Raman medium.

According to another aspect of the disclosure, the wavelength discriminator of any of the above aspects the opposite sides of the Raman medium is coated with the discriminator. Alternatively, the wavelength discriminator of any of the above aspects is coated on one of the opposite sides of the Raman medium, but is spaced from the other side.

The solid state Raman medium of any of the above aspects is configured with a plurality of fast axis collimators arranged in a row between the discriminator and one of the opposite sides of the Raman medium. In addition, the solid state Raman medium further includes a slow axis collimator spaced downstream outside the output of the crystal.

In a further aspect of the disclosure, the solid state Raman medium of any of the above aspects can be an anisotropic, isotropic, uniaxial or biaxial crystal. The crystal may be selected from Ba(NO3)2, KGd(WO4)2, LiLo3, LiNbo3 or any other crystal considered to be a Raman-active medium.

In accordance with still another aspect of the disclosure, a Raman laser source is configured with an optical pump outputting pump light at a fundamental frequency along a linear path. The Raman source further includes a one piece upstream coupler configured to pass the pump light at the fundamental frequency, and a one piece downstream coupler configured to reflect the pump light. The upstream and downstream couplers define an outer optical cavity there-between and provide at least one round trip for the pump light within the outer cavity.

Furthermore, the Raman source in accordance with the previous aspect further has a one piece intermediate coupler spaced inwards from the upstream and downstream couplers and configured to be transparent to the pump light. Accordingly, the upstream and intermediate couplers define an inner optical cavity. The laser also includes a solid state Raman medium located within the inner optical cavity and configured to sequentially convert the pump light to Stokes wave frequencies υ₁-υn of the fundamental frequency.

The one piece upstream coupler is partially transparent to pump light and is configured to focus the transmitted pump light into the Raman medium. The downstream face of the upstream coupler fully reflects Stokes waves. The one piece downstream coupler fully reflects the pump light and is fully transparent to generated Stokes wave frequencies. Finally, the one piece intermediary coupler has an upstream face partially reflecting the desired Stokes wave frequency back into the inner optical cavity while being fully transparent to frequencies higher than the desired frequency. The downstream face of the intermediary coupler is configured to collimate the pump and Stokes wave frequencies propagating towards the downstream coupler.

Another aspect of the disclosure relates to the laser pump of any of the above aspects. The laser pump is configured to operate in a continuous wave or pulsed regime. The laser pump outputs the pump light in single transverse mode or multiple transverse modes, polarized or unpolarized in a wavelength range varying from about 200 nm to about 2 μm. In a pulse regime, the fiber laser source may output pulses in a ps or longer temporal regimes.

In yet another aspect of the disclosure relates to any of the above aspects disclosing a pulsed operating regime of the fiber laser pump. In particular, the downstream coupler of the outer cavity is displaceable relative to the upstream coupler such that the reflected leading portion of forward propagating pulse of pump light overlaps the railing portion of this pulse which is still within the Raman medium. Accordingly, the inner cavity is constantly pumped.

### BRIEF DESCRIPTION OF THE DRAWINGS

The above and other configurations and features will become more readily apparent from the specific description in conjunction with the following drawings, in which:

FIG. 1 illustrates the disclosed Raman laser source featuring the zigzag light path of light through a Raman medium.

FIG. 2 is the Raman laser source of FIG. 1 with a modified wavelength selecting discriminator.

FIGS. 3A, 3B and 3C illustrate the concept of the disclosed Raman laser source in accordance with another aspect in which light linearly propagates through the Raman medium.

FIG. 4 illustrates the Raman laser source with a cavity of FIGS. 3A and 3B.

FIG. 5 is the disclosed Raman laser source with a cavity of FIG. 3C.

FIGS. 6A and 6B illustrate a modus operandi of Raman laser sources of respective FIGS. 4 and 5.

FIG. 7A-7C illustrate sequential interaction between forward-propagating and backreflected portions of each individual pulse.

### SPECIFIC DESCRIPTION

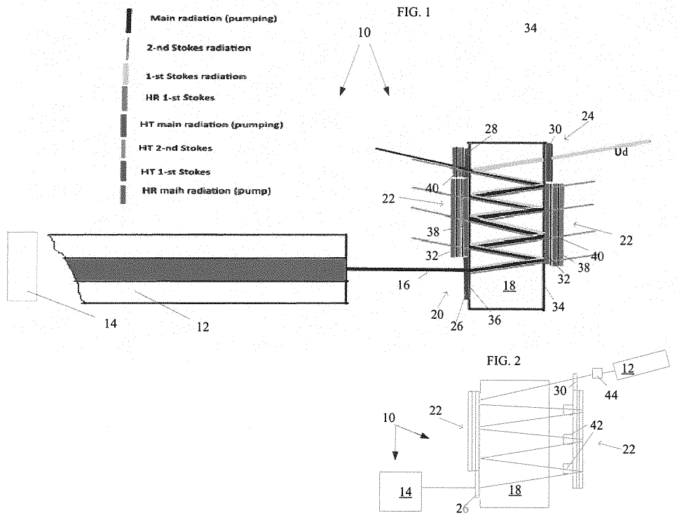

FIG. 1 illustrates a crystalline Raman laser source 10, configured in accordance with one aspect the disclosed concept, includes an external fiber laser pump 14 which operates in any of continuous wave (CW), quasi-QW (QCW) or pure pulsed regimes outputting polarized or unpolarized pump light 16 at a fundamental frequency υf. Depending on the desired output power, fiber laser source 14 may have a master oscillator power fiber amplifier or just one or more fiber lasers (oscillators). Upon propagating over free space, pump light 16 is coupled into a crystalline Raman medium 18 through an input 20 such that, within Raman medium 18, pump light 16 is guided along a zigzag path. The Raman medium 18 used in the disclosed structure may include Ba(NO3)2, KGd(WO4)2, LiLo3, LiNbo3, BaWO₄ or any other crystal considered to be a Raman-active medium operative to sequentially convert fundamental wave frequency υf to first Stokes wave frequency υ₁-υn. The spectral range of Stokes wave frequencies can be very broad, as well known to one of ordinary skill in the Raman technology.

A wavelength discriminator 22, coupled to opposite sides of Raman medium 18, is configured to guide a desired Stokes wave frequency υd along Raman medium 18 until the desired Stokes is decoupled from the Raman crystal through output 24. The wavelength discriminator 22 is configured with a plurality of layers configured to selectively transmit and reflect incident Stokes waves.

Given only as an example, wavelength discriminator 22 includes a multi-part layer 26 (blue) which is transparent to pump light 16. Accordingly, pump light 16 is coupled into Raman medium 18 without appreciative losses through input 20. The remaining pump light is decoupled from Raman medium 18 through another part of layer 26 coated upon pump light output 28 which is located immediately before output 24 for the desired Stokes.

The illustrated example is represented by Raman laser source 10 operative to output a first Stokes shown in yellow. Accordingly, all layers except for a layer 30, which defines output 24, reflect the desired first Stokes. The Raman phenomenon includes converting the energy of precedent Stoke or Stokes at higher frequencies to the desired subsequent stokes. In other words, as shown, the pump light at fundamental frequency transfers its energy to the desired first Stokes as soon as it reaches a threshold for the desired frequency. It may happen immediately upon the coupling of the pump light into Raman medium 18 or later upon first reflection of the pump light from wavelength discriminator 22. Furthermore, it is now the first Stokes that turns to be pump light for the second Stokes, which is undesirable in the current example. Accordingly, a layer 32 (blue) is coated upon a side 34 of Raman medium 18 from the very upstream end of the crystal so that whenever the second Stokes is generated and incident on side 34, it is sifted out right away. Meanwhile, red layer 38 and violet layer 40 are configured to reflect fundamental and desired (first) wave frequencies back into the Raman crystal. The reflected light at fundamental and desired first frequencies is incident on opposite side 36 of Raman medium 18 where layers 40, 38 and 32 are coated in the sequence opposite to that on side 32. Therefore waves at fundamental and desired frequencies are reflected back into the Raman crystal by respective layers 40 and 38, while outer layer 32 is being transparent to the second Stokes. The layers 40 and 32 extend over layer 26 which defines final output 28 for all undesired frequencies right before the desired Stokes wave exits the Raman crystal via output 24. The above disclosed operation of wavelength discriminator 22 continues along the entire length of the Raman crystal.

FIG. 2 illustrates a modification of Raman laser source 10 of FIG. 1. As well known, the greater length of Raman active medium 18 increases the conversion efficiency. However, as light propagates through the medium, it tends to diverge reducing it intensity that worsens the conversion efficiency.

This undesirable effect is taken into account by the wavelength discriminator of FIG. 2 which has the same configuration as that of FIG. 1, but the part of discriminator 22 facing side 34 is spaced from this side. To correct undesired beam divergence, a plurality of fast axis collimators 42 are arranged in a row between the discriminator and the other side of the Raman medium and located either on the discriminator or directly on side 34. Preferably, only one slow axis collimator 44 is provided downstream from exit 24 for the desired Stokes wave. Nonetheless, the circumstance may require having multiple collimators 44 provided along the light path downstream from respective fast axis collimators 42.

Referring to both FIGS. 1 and 2, Raman laser source 10 preferably operates in UV, near infrared and mid infrared spectral ranges. Since the rare earth dopants implanted in fibers have a limited range of standard output wavelengths, it is necessary to use other optical elements in combination with the fiber laser source to obtain nonstandard wavelengths. For example, it is well known to use nonlinear crystals that provide the possibility of obtaining, for example, Green and UV outputs by means of second harmonic and third harmonic generation techniques. A typical optical scheme would have fiber laser pump operating in a 1 μm spectral range and one or two nonlinear crystals converting pump light into Green and UV output. FIG. 1 thus illustrates fiber laser pump 14 and second harmonic generator—nonlinear crystal 12—converting pump light to its second harmonic known as Green light. The nonlinear crystal 12 is located upstream from Raman medium 18 and initially converts the pump radiation to the desired second harmonic which then is coupled into Raman medium 18. FIG. 2 illustrates nonlinear crystal 12 downstream from Raman medium 18. Here the Raman crystal initially shifts pump light in a 1 μm spectral range to the desired Stokes wave frequency, whereas nonlinear crystal 12 provides double frequency conversion of the desired Stokes. The number of nonlinear crystals can be increased if, for example, it is desirable that the fundamental frequency be tripled, which in the given example corresponds to UV light. As will be disclosed below in somewhat greater detail, nonstandard wavelength outputs are widely used in numerous industrial and research applications and particularly those that require a 200 nm-2 μm wavelength range.

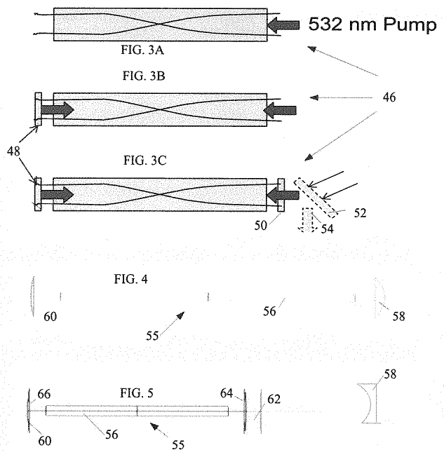

Referring to FIGS. 3A-3C, the Raman conversion scheme may feature patterns of light path within active Raman media different from the zigzag path of FIGS. 1 and 2. For example it is rather customary to linearly guide pump light through a Raman crystal 46. The number of linear paths through the Raman crystal, however, may be different.

FIG. 3A illustrates a single pass of pump light at, for example, 532 nm through Raman crystal 46. As pump light at the fundamental frequency propagates one time through Raman crystal 46 from right to left, it converts to Stokes wave frequencies. FIG. 3B illustrates a dual pass (round trip) scheme of light propagation. Compared to FIG. 3A, in FIG. 3B interaction between the pump light and Stokes is twice increased, because of output mirror 48 functions as a spatial filter reflective to the pump light and, for example, first Stokes wave frequency, but transparent to all parasitic Stokes. FIG. 3C illustrates a multipass scheme featuring a cavity which encloses Raman crystal 48 and is defined between reflective mirrors 50 and 48. Both mirrors are transparent to all parasitic Stokes, with mirror 48 being highly reflective to the fundamental and desired Stokes wave frequencies. The partially transparent mirror 52 guides the output desired Stokes wave in a direction of arrow 54.

Turning to FIGS. 4 and 5, a Raman laser source 55 of both figures includes a solid state Raman medium 56, selected from the above-disclosed crystalline materials, which is linearly traversed by pump light. The input and output couplers 60 and 58, respectively, define a cavity enclosing Raman medium 56. One of the advantages of sources 55 includes the use of one-piece optical meniscus for input and output couplers that perform more than one operational function.

The Raman source 55 of FIG. 4 thus operates with one piece upstream end coupler 60 configured to partially pass pump light at the fundamental frequency from an external fiber laser pump in both directions and reflect all Stokes back into the cavity. The one piece downstream coupler 58 is structured to reflect all pump light back while transmitting partially desired Stokes and fully all other Stokes waves outside the cavity where the desired Stokes is further filtered out by, for example, a dichroic mirror. The reflection of pump light provides an increased interaction path between pup light and Raman medium. The inner faces of respective input and output coupler 60 and 58, i.e., the faces opposing one another, are configured to focus the pump light into Raman medium 56.

Referring to FIG. 5, input and output one-piece end couplers 60 and 58, respectively, define an outer cavity providing the pump light with a round trip within the outer cavity, with input coupler 60 being partially transparent to the pump light. The downstream face 66 of coupler 60 fully reflects all Stokes waves generated in Raman medium 56, as explained below.

The Raman laser source 55 further has an intermediate optical one-piece optical meniscus 62 which together with input coupler 60 define an inner cavity enclosing Raman medium 56. The intermediary meniscus 62 is configured with an inner face 64 partially reflecting and focusing the reflected desired (and lower frequency) Stokes wave(s) into Raman medium 56, while passing the rest of light further into the outer cavity. The transferred desired and parasitic Stokes waves are then fully decoupled through output coupler 58 while the pump light is fully reflected and focused into Raman medium 56 upon passing through intermediate meniscus 62. The presence of intermediate meniscus 62 allows the desired Stokes to traverse the inner cavity more times while the pump light completes a round trip through the outer cavity. Outside the outer cavity, the desired Stokes is further separated from the rest of decoupled light by any suitable means.

To design high efficiency longitudinal Raman converters several factors should be taken into account. For example, in the pulsed pumping schemes it is necessary to evaluate pump pulse delay, beam diameter for pump and Raman radiations, pump and Raman radiations overlap and focal position of pump and Raman radiations in the cavities.

Referring to FIGS. 6A and 6B, it should be remembered that the pulse width is somewhat greater than the length of Raman crystal. Accordingly, it is possible to keep the cavity within which pump light circulates constantly pumped in both schemes of respective FIGS. 4 and 5.

FIG. 6A illustrates the mechanism of operation in scheme of FIG. 4. As the pulse of the fundamental light is coupled into and propagates through the cavity towards output coupler 58, its leading edge is reflected back into Raman medium 56 while a trailing edge of the forward propagating pulse is still within the medium. The danger of this approach includes possible degradation of the Raman crystal because of overly high peak power Pp since forward propagating and backreflected parts constructively interfere.

The dangerously high peak pump power within the Raman crystal can however be controlled in the scheme of FIG. 5 as illustrated in FIG. 6B. This is realized by displacing output coupler 58 relative to input coupler 60 such as to control the overlap between the reflected front edge with the trailing part of this pulse at any desired location within Raman medium 56, provided the inner cavity remains unchanged.

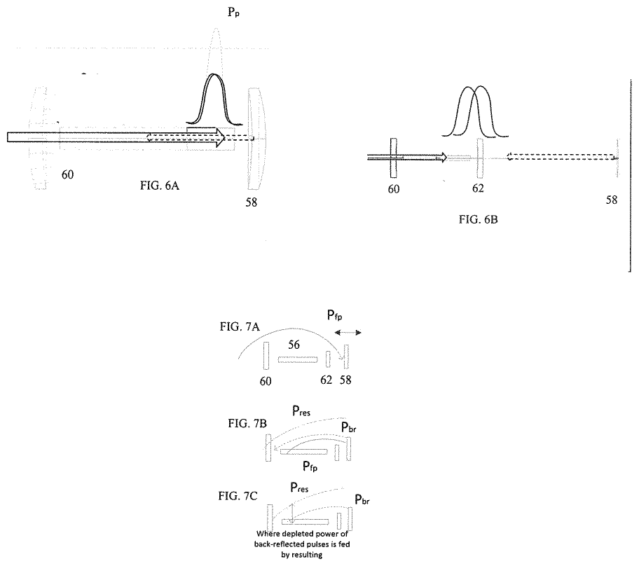

Referring to FIGS. 7A-7C illustrate sequential optical transformation of each individual pulse of pump light within the outer cavity of FIG. 5. As mentioned above, the width of each pulse 64 is greater than the longitudinal dimension of Raman crystal 56. FIG. 7A illustrates a forward propagating pulse Pfp coupled into the outer cavity. As it continues the propagation towards downstream/output coupler 58, a front edge of pulse 60 incident on the output coupler is reflected back (Pbr) towards input coupler 60, as shown in FIG. 7B. FIG. 7C illustrates a step when the trailing portion of pulse 60 is coupled into Raman crystal 56. By this time, the power of pump light carried in the trailing portion of pulse 60 is relatively small which affects the conversion efficiency. However, the resulting pump power Pres-interference between backreflected Pbr and Pfp portions of pulse 60—is sufficient to provide effective frequency conversion when the upstream end of Raman crystal 56 is under the trailing portion of pulse 60.

As mentioned above, Raman mechanism is widely used in a great variety of applications. In fact, the frequency conversion problem is particularly important in the field of telescope optics. Atmospheric distortions require the use of guide stars to compensate for these distortions in telescopes. One form of guide star, in turn, is best produced by a laser source emitting at the sodium yellow line at 589 nm wavelength. Other forms of guide stars can be produced by illuminating the resonance transitions of alkali metals such as K, Li, Rb, or by illuminating other metal atom transitions for metals such as iron, or any metals formed in the upper atmosphere due to meteor bombardment. At present the 589 nm sodium line is most commonly used. The disclosed Raman laser source can be ideal for this application and have substantial advantages over other types of lasers. For example, typically, the 589 nm is conventionally derived by sum generation of two Nd:YAG lasers. One of these is a frequency-doubled Nd:YAG laser pumped by a dye laser. Such dye lasers require dye fluids which have limited lifetime and are subject to freezing or leaking. The first Nd:YAG emits at 1,064 nm and the second at 1.32 μm. By coincidence these two generate the sum of the desired 589 nm wavelength. However, it is well-known that the summing of two independent lasers requires careful control of the pulse timing such that the process remains efficient. In practice, pulse timing jitter prevents the stable generation of yellow output by sum generation of two Nd:YAG lasers.

Still another application that can benefit from the disclosed Raman laser source is an RGB engine. One of the possibilities in utilizing the disclosed Raman laser source is to use three operating in tandem with respective designated fiber laser pumps such as to produce all three colors. Still another possibility is to use a single Raman laser source as disclosed with multiple fiber laser pumps. And yet another possibility is to use a single fiber laser pump and single Raman laser source of this disclosure.

1. A Raman laser source, comprising:
a laser pump operative to emit pump light at a fundamental frequency along a path; and
a crystal Raman medium zigzagged by the pump light between input and output of the Raman medium such that the pump light sequentially converts to Stokes wave frequencies υ₁-υn, the Raman medium having spaced opposite sides bridging the input and output; and
a wavelength discriminator coupled to the opposite sides and configured to guide a desired Stokes frequency to the exit of the Raman medium while being transparent to Stokes wave frequency which is lower than the desired frequency.

2. The Raman laser source of claim 1, wherein the output of the Raman medium is configured to be transparent to the desired Stokes wave frequency while reflecting the pump light at the fundamental frequency back into the Raman medium towards the input.

3. The Raman laser source of the above claims, wherein the wavelength discriminator is configured with a plurality of discreet reflectors which, from inner out, reflect respective fundamental frequency, Raman wave frequencies higher than the desired Raman wave frequency and desired Raman wave frequency back into the Raman medium.

4. The Raman laser source of the above claims, wherein the wavelength discriminator is coated upon the opposite sides of the Raman medium.

5. The Raman laser of claims 1-3, wherein the wavelength discriminator is coated on one of the opposite sides of the Raman medium but is spaced from the other side.

6. The Raman laser source of claim 4 further comprising a plurality of fast axis collimators arranged in a row between the discriminator and the other side of the Raman medium.

7. The Raman laser source of claim 5 further comprising a slow axis collimator downstream from and in optical contact with the output of the Raman medium.

8. The Raman laser source of the above claims, wherein the crystal Raman medium comprises Ba(NO3)2, KGd(WO4)2, LiLo3, LiNbo3 or any other crystal considered to be a Raman-active medium.

9. The Raman laser source of the above claims, wherein the laser pump is configured to operate in a continuous wave or pulsed regime, the pump light being radiated in single mode or multiple modes, polarized or unpolarized, the crystal Raman medium being anisotropic, isotropic, uniaxial or biaxial.

10. The Raman laser source of the above claims, wherein the pump light is emitted in a wavelength range varying from about 200 nm to about 2 μm, the ump being configured to operate in a continuous wave regime or pulsed regime.

11. The Raman laser source of claim 10, wherein the pulsed pump is a fiber laser source operating in a ps and longer regime.

12. The Raman laser source of any of the above claims, wherein the desired Stokes corresponds to the sodium yellow line at 589 nm and is used for guide star applications to correct the atmospheric distortions of optical telescopes.

13. A Raman laser source comprising:
an optical pump outputting pump light at a fundamental frequency along a linear path;
a Raman laser configured with:
a one piece upstream coupler configured to partially pass the pump light at the fundamental frequency, and a one piece downstream coupler configured to fully reflect the pump light, wherein the upstream and downstream couplers define an outer optical cavity therebetween and are configured to provide a round trip for the pump light within the outer cavity;
a one piece intermediate coupler spaced inwards from the upstream and downstream couplers and configured to be transparent to the pump light, the upstream and intermediate couplers defining an inner optical cavity, and
a solid state Raman medium located within the inner optical cavity and configured to sequentially convert the pump light to Stokes wave frequencies υ₁-υn of the fundamental frequency, wherein
the one piece upstream coupler has an upstream face configured to focus the pump light within the Raman medium along the linear path towards the downstream coupler,
the one piece downstream coupler has an upstream face highly reflective to the pump light such as to to focus it within the Raman medium along the linear path towards the upstream coupler, the downstream coupler fully transmitting generated Stokes wave frequencies, and
the one piece intermediate coupler has an upstream face partially reflecting the desired Stokes frequency back into the inner optical cavity and being transparent to frequencies higher than the desired frequency, a downstream face of the intermediary coupler being configured to collimate the pump and Stokes wave frequencies propagating towards the downstream coupler.

14. The Raman laser source of claim 13, wherein the output coupler is displaceable to controllably vary a length of the outer cavity.

15. The Raman laser source of claim 13 further comprising a wavelength filter outside the outer cavity so as to separate the desired Stokes wave frequency from the rest of the decoupled light.
